(19) United States
(12) Patent Application Publication
(10) Pub. No.: US 2015/0145470 A1
(43) Pub. Date: May 28, 2015

(54) MICRO-ENERGY HARVESTING DEVICE FOR SPACE-LIMITED APPLICATIONS

(71) Applicant: University of Utah Research Foundation, Salt Lake City, UT (US)

(72) Inventors: Hanseup Kim, Salt Lake City, UT (US); Jiyoung Son, Salt Lake City, UT (US)

(21) Appl. No.: 14/553,703

(22) Filed: Nov. 25, 2014

Related U.S. Application Data
(60) Provisional application No. 62/002,066, filed on May 22, 2014.
(60) Provisional application No. 61/909,269, filed on Nov. 26, 2013.

(51) Int. Cl. H02K 35/02; H02J 7/00

(52) U.S. Cl. CPC H02K 35/02; H02J 7/0042
USPC 320/107; 290/1 R

(57) ABSTRACT

Implementations of the present invention relate to apparatuses, systems, and methods for harvesting mechanical energy from micro-energy sources and converting that energy into electrical energy. Such mechanical energy sources may be from common motions or processes such as the movement of cars or people. A device for the harvesting of such excess energy may utilize a circulation channel in which magnets may induce currents in coils as the magnets follow a continuous path.

### CROSS-REFERENCE TO RELATED APPLICATIONS

This application claims priority to and the benefit of U.S. Provisional Patent Application No. 62/002,066, filed May 22, 2014, and entitled “MICRO-ENERGY HARVESTING DEVICE FOR SPACE-LIMITED APPLICATIONS,” and to U.S. Provisional Patent Application No. 61/909,269, filed Nov. 26, 2013, and entitled “FLEXIBLE DEVICES, SYSTEMS, AND METHODS OF HARVESTING ENERGY,” both of which are incorporated herein by reference in their entirety.

### BACKGROUND OF THE DISCLOSURE

1. The Field of the Invention

Generally, this disclosure relates to converting mechanical energy into electrical energy. More specifically, the present disclosure relates to the harvesting of mechanical energy from common motions or processes by capturing energy normally lost to the surrounding environment.

2. Background and Relevant Art

Energy production is relevant to many applications. Many devices in daily life demand electrical energy to operate. Such devices may receive energy from a centralized energy source (i.e. an electrical grid provided by a power company) or from a portable, localized energy source (i.e. a battery, generator, etc.). For example, a portable electronic device, such as a cellular telephone, may utilize a portable energy storage source to provide a remote supply of energy that stores energy from a centralized energy source to provide energy when connected thereto, but the provides electricity to the device as needed when not connected to the centralized energy source. A portable energy storage source may be more compact and therefore more suitable to certain applications. Typically, these portable energy storage sources must be periodically connected to a centralized energy source in order to recharge them and continue supplying energy to electrical devices.

There are many individual energy sources that could provide the requisite energy to operate such portable electronic devices or to provide energy to recharge such portable energy storage sources. However, many such individual energy sources are not currently utilized for power generation due to the small scale and/or production capacity of the energy source. These individual “micro-energy” sources are commonly mechanical energy sources. For example, such micro-energy sources may be a person walking or running that will generate mechanical energy that is dissipated against the ground, or the movement of automobiles along a road surface that produces repeated mechanical energy that is dissipated in the road. In each case, the energy is produced for a primary purpose of movement, but excess energy is lost to the environment.

The mechanical energy of such mechanical power sources may be harvested by converting the mechanical energy to electrical energy by means of micro-energy harvesting. For example, the mechanical energy may be converted to electrical energy through electromagnetic conversion. The mechanical energy may be used to move a magnet through the interior of a wire coil and thereby induce a current in a wire. Such an electromagnetic conversion may be applied in a linear motion to create an oscillating magnet and, therefore, magnetic field to charge a battery or supply electricity to operate an electronic device. The oscillating magnet however, is limited by the scale of the source of mechanical energy or scale of the channel in which the magnet may oscillate. For example, to harvest the excess energy of a person walking, the linear motion of the magnet would be limited to a size that could be unobtrusively affixed to the person. While the energy harvesting could be increased to an extent by increasing the power of the magnet, that would typically require increasing the size of the magnet and the size of the wire (to increase the associated magnetic capacity of the coil), and therefore would increase the overall mass of the energy harvesting device and begin to affect movement of person.

### BRIEF SUMMARY OF THE DISCLOSURE

The present disclosure may address one or more of the foregoing or other problems in the art with devices, systems, and methods for manufacturing, installing and using micro-energy harvesting devices. A micro-energy harvesting device according to the present disclosure may include a plurality of chambers and plurality of channels configured to circulate a fluid therebetween. At least one of the channels may be in fluid communication with a circulation channel. The movement of the fluid through the circulation channel may move a plurality of magnetic components interspersed with non-magnetic components. The movement of the plurality of magnetic components past a plurality of conductive coils may convert the mechanical movement into electrical energy. Additionally, the conductive coils may be connected to an energy storage device.

In other implementations, a micro-energy harvesting device may include a channel configured to be pressurized and a fluid contained with the channel. The channel may be in fluid communication with a chamber that contains a compressible fluid. The fluid may also be configured to move a plurality of magnetic elements through a plurality of electrically conductive coils. The plurality of magnetic components may be spaced apart from each other by a plurality of nonmagnetic components such that the magnetic and nonmagnetic components form an alternating series of magnetic and nonmagnetic components. Additionally, the chamber containing the compressible fluid may be a spiral, or similarly shaped, channel.

In another implementation, a method for harvesting micro-energy is provided. The method may include providing a micro-energy harvesting device and using that device to receive an input force with the first chamber. The force may then be transmitted to the fluid disposed in the first chamber. The fluid may move from the first chamber through the circulation channel and into the second chamber. When the fluid moves from the first chamber through the circulation channel and into the second chamber, the movement of the fluid may move the plurality of magnetic components. The device may then convert the movement of the plurality of magnetic components into electrical energy.

Additional features and advantages of exemplary implementations of the disclosure will be set forth in the description which follows, and in part will be obvious from the description, or may be learned by the practice of such exemplary implementations. The features and advantages of such implementations may be realized and obtained by means of the instruments and combinations particularly pointed out in the appended claims. These and other features will become more fully apparent from the following description and appended claims, or may be learned by the practice of such exemplary implementations as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. For better understanding, the like elements have been designated by like reference numbers throughout the various accompanying figures. While some of the drawings may be schematic representations, at least some of the drawings may be drawn to scale. Understanding that these drawings depict only typical embodiments of the disclosure and are not therefore to be considered to be limiting of its scope, the invention will be described and explained with additional specificity and detail through the use of the accompanying drawings in which:

FIG. 1 illustrates a schematic representation of a microfluidic device for harvesting energy in accordance with at least one embodiment of the present disclosure;

FIG. 2A illustrates a schematic representation of a state in a sequence of a magnetic element passing through a coil of a microfluidic device for harvesting energy in accordance with at least one embodiment of the present disclosure;

FIG. 2B illustrates a schematic representation of another state in a sequence of a magnetic element passing through a coil of a microfluidic device for harvesting energy in accordance with at least one embodiment of the present disclosure;

FIG. 2C illustrates a schematic representation of yet another state in a sequence of a magnetic element passing through a coil of a microfluidic device for harvesting energy in accordance with at least one embodiment of the present disclosure;

FIG. 2D illustrates a schematic representation of one other state in a sequence of a magnetic element passing through a coil of a microfluidic device for harvesting energy in accordance with at least one embodiment of the present disclosure;

FIG. 2E illustrates a schematic representation of still another state in a sequence of a magnetic element passing through a coil of a microfluidic device for harvesting energy in accordance with at least one embodiment of the present disclosure;

FIG. 3 illustrates a graph of voltage as a function of time, representative of the voltage generated by the magnetic element passing through the coil at each stage illustrated in the FIGS. 2A-2E;

FIG. 4A illustrates a top view of a schematic representation of a microfluidic device for harvesting energy in accordance with at least one embodiment of the present disclosure in a state of operation;

FIG. 4B illustrates a top view of a schematic representation of the microfluidic device for harvesting energy of FIG. 4A in another state of operation;

FIG. 4C illustrates a top view of a schematic representation of the microfluidic device for harvesting energy with a self-recovering chamber;

FIG. 5 illustrates a top view of a schematic representation of the microfluidic device for harvesting energy with a circulation channel for the conversion of mechanical energy to electrical energy;

FIG. 6 illustrates a top view of a schematic representation of a microfluidic device for harvesting energy with a paddlewheel for the conversion of mechanical energy to electrical energy;

FIG. 7 illustrates perspective view of a flywheel connected to the microfluidic device of FIG. 6; and

FIG. 8 illustrates an embodiment of a micro-energy harvesting device having a self-flow-stop mechanism.

### DETAILED DESCRIPTION

One or more implementations of the present disclosure relate to systems, methods, and devices for harvesting energy by converting mechanical energy into electrical energy. In particular, the mechanical energy can be harvested by converting the movement or operation of another system or object into electrical energy. In some embodiments, the mechanical energy can be harvested from energy expended during the normal motion or operation of devices such as cars, bicycles, or doors, or during activities such as simply walking. In addition, energy can be harvested from the surface over which these objects move, such as roads, sidewalks, or railroad tracks. In other embodiments, energy can be harvested from non-mechanical systems such as tides, waves, or oscillations of structures due to the wind. In still other embodiments, the energy harvesting system can be adapted to accept various forms mechanical energy such as compression or other applications of force.

In some embodiments, the energy harvesting system converts movements of an object into electrical energy. In particular, the system may be able to transform pressure applied to one section of the system into electrical energy. For example, the system may be able to receive input forces and use them to move magnets or magnetic components through or past a series of coils and induce a current therein. As will be used herein, the term “coil” refers to a plurality of loops of wire or other electrically conductive material.

In one embodiment, the system may receive forces and transmit those forces to the magnetic components by way of a fluid. Unless otherwise specified, the term “fluid” as used herein refers to a compressible or incompressible fluid that may be in the form of a liquid, semi-liquid, gas, or combinations thereof. As a first chamber compresses, it may force the fluid through a channel, and the fluid may move a magnetic component past or through a coil. The fluid may act on the magnetic components either by a direct pressure, such as when the magnetic component is approximately the same size as the channel through which the fluid is following; through a mechanical linkage, such as fluid rotating an axle, which then moves a magnetic component outside the channel; by another force such as friction, such as when the magnetic component is smaller than the channel through which the fluid flows and is simply carried along by the flow of fluid; or by a combination thereof.

In some embodiments, the system may be able to amplify or de-amplify the force applied to the system when the force is subsequently applied to the magnetic components. For example, in an embodiment that de-amplifies the force applied to the system, the channel containing the fluid may be connected to a first chamber and the first chamber may be significantly larger than the diameter of the channel. This may allow the system to accept very large input forces and to reduce the pressure from the force when applied to the magnetic components so to not rupture the channels. In addition, such an embodiment would also allow a large chamber to compress very slightly and still move magnets within the channels a significant amount. This may enable several advantages such as moving many magnetic components through or past a coil and inducing a larger current or simply requiring very little compression of the first chamber and thereby rendering the system largely transparent to users, such as when the device is stored within the sole of a shoe.

However, in such an embodiment, the distance the magnetic components may move through the channel may be limited by the size of the device. For example, in the above described embodiment, the maximum size of the device may be limited by the sole of the shoe. In order to overcome this limitation, a circulation chamber may be used to allow circular motion of the magnetic components such that the magnetic components may continue to move to the full extent the energy from the input force may move them despite the compact size of the device.

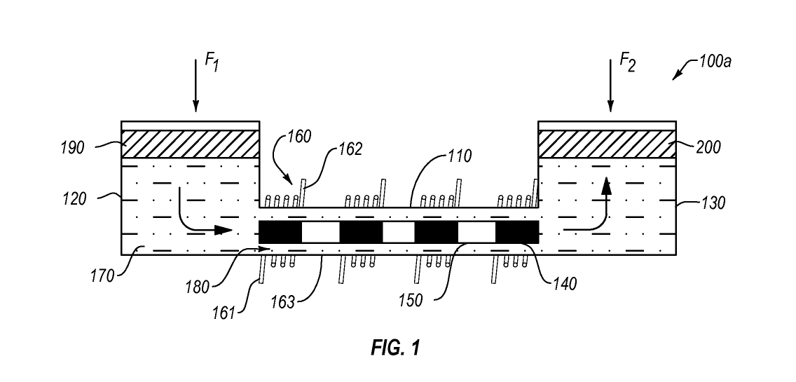

As depicted in FIG. 1, an embodiment of a micro-energy harvesting device 100a may comprise a channel 110 providing fluid communication between a first chamber 120 and a second chamber 130. A series of a plurality of magnetic components 140 spaced apart from one another by a plurality of nonmagnetic components 150 may be disposed within the channel 110. In some embodiments, the magnetic components 140 may comprise rare earth magnets. In other embodiments, the magnetic components 140 may comprise neodymium. The alternating magnetic and nonmagnetic components 140, 150 may induce a current as they pass through or near a one or more coils 160, wherein at least one of the one or more coils may have a first lead 161 and a second lead 162 and may be disposed around an outer surface 163 of the channel 110. For example, when an input force F₁ is applied to the first chamber 120, an upper surface of the first chamber 190 may move, increasing the pressure within the first chamber 120 and applying the force F₁ to a fluid 170 and forcing the fluid 170 toward the second chamber 130 via the channel 110. An upper surface of the second chamber 200 may then rise in accordance with an increase in the volume of the second chamber 130.

When the fluid 170 flows through the channel 110, it may apply a force to the magnetic components 140 and nonmagnetic components 150. The resulting movement of the magnetic components 140 and nonmagnetic components 150 through the channel 110 may induce a current in the coils 160, which may flow between the first and second leads 161, 162 to provide electrical energy either to power a device or to charge an electrical energy storage source such as a battery by an electrical connection between the first and second leads 161, 162 and the terminals of the electrical energy storage device. As mentioned earlier, the force on the magnetic components 140 and nonmagnetic components 150 may be a direct force applied by the fluid 170 on a cross-sectional surface of the magnetic components 140 and nonmagnetic components 150, or it may be due to friction of the fluid 170 on the magnetic components 140 and nonmagnetic components 150 as the fluid moves past in an annular space 180 within the channel 110. The magnetic components 140 may have a diameter approximately equal to a diameter of the channel 110. In another embodiment, the magnetic components 140 and/or nonmagnetic components 150 may have a diameter about 70% of the diameter of the channel 110. In yet other embodiments, the magnetic components 140 and/or nonmagnetic components 150 may have a diameter between 70% and 100% of the diameter of the channel 110.

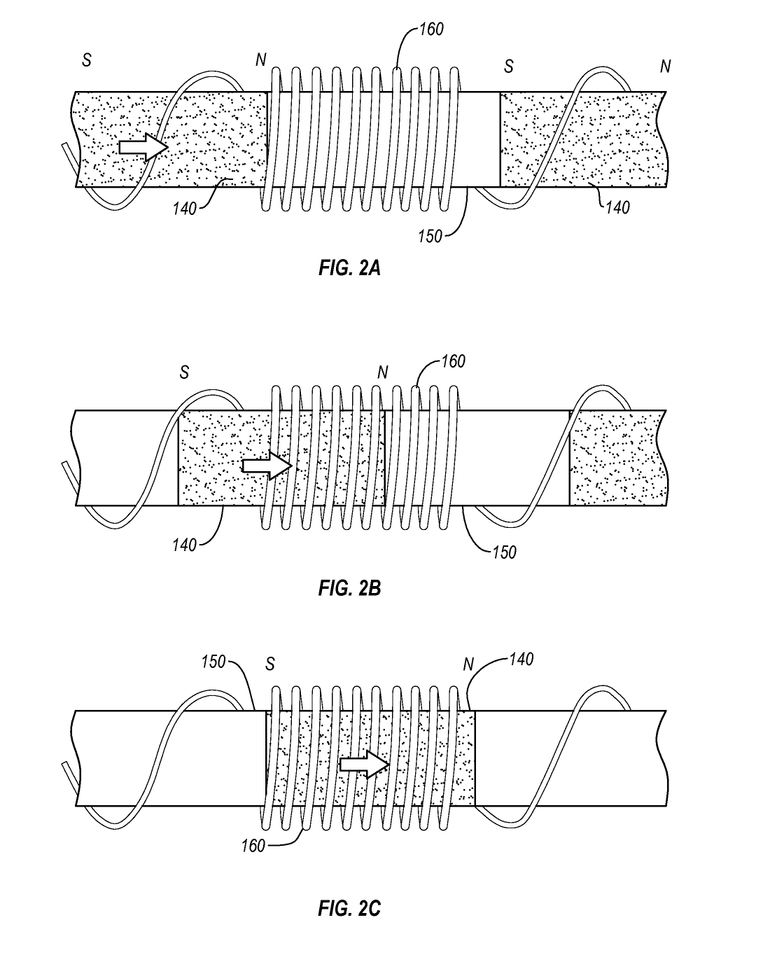

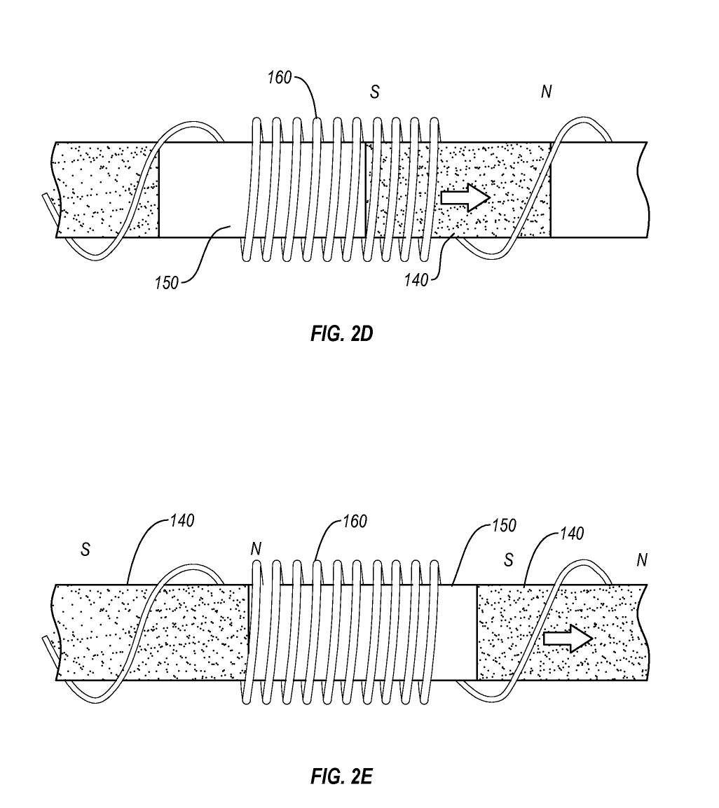

As described herein, the magnetic components 140 can induce current in the coils 160 as the magnetic components 140 move along the channel 110. More specifically, as illustrated in FIGS. 2A-2E and 3, the magnetic components 140 can move in the first direction together with the nonmagnetic spacers 150. As each of the magnetic components 140 passes through a corresponding coil 160, the movement of the magnetic components 140 inside such coils 160 can induce current in each of such coils 160. FIG. 3 illustrates the change in voltage with respect to time, as the magnetic components 140 move through the coil 160. Particularly, points A, B, C, D, and E illustrate voltage produced by the magnetic components 140 at the different positions along the coils 160, illustrated in corresponding FIGS. 2A-2E.

The power output of the coils 160 can vary depending on the number of windings as well as on the diameter of wire used in the coils 160. Particularly, as the diameter of the wire is increased, the resistance will increase proportionately and will reduce the overall amount of power output. For example, a 150 μm diameter wire can be used for the coils 160. Other diameters, which may be greater or smaller than 150 μm, can be used for the coils 160. Furthermore, the coils 160 may have one or more layers. In some embodiments, a single layer of windings may form the coils 160. In other embodiments, however, the coils 160 can be formed from multiple layers of windings, which may improve the performance (i.e., increase the power output) of the energy harvesting device.

Movement of the magnetic components 140 and nonmagnetic components 150 of FIGS. 1 and 2A-E may be limited by the length of the channel 110 in which they are contained. Furthermore, their motion will be indirectly inhibited because the flow of the fluid 170 is inhibited by the linear nature of the channel 110 providing the fluid communication between the first chamber 120 and the second chamber 130.

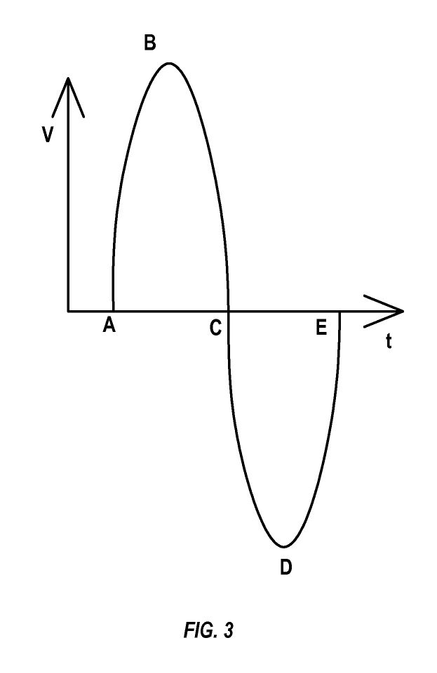

Referring now to FIGS. 4A-B, a first chamber 210 and a second chamber 220 may be in fluid communication with one another by a delivery channel 230 and a return channel 240. It should be noted that the designations of the “first” and “second” chambers are intended for the purposes of illustrating the various embodiments described herein and are not meant to be limiting. Accordingly, as used herein, the terms “first” and “second” chambers are entirely interchangeable. Likewise, the designations of “delivery” and “return” channels are merely illustrative of fluid motion relative to the first and second chambers. As the device is intended to produce a circular behavior, it will be appreciated that the embodiment described herein is symmetrical and functionality is irrespective of a particular orientation.

The delivery channel 230 may have one or more delivery microvalves 250 disposed therein and configured to allow flow through the delivery channel 230 from the first chamber 210 to the second chamber 220. The return channel 240 may have one or more return microvalves 260 disposed therein and configured to allow flow through the return channel 240 from the second chamber 220 to the first chamber 210. The one or more microvalves 250, 260 may allow substantially unidirectional flow of a fluid 170 disposed in the system.

The first chamber 210 and the second chamber 220 may be configured to change volume. For example, a chamber may reduce in volume as force is applied and/or fluid 170 exits the chamber. In another example, a chamber may increase in volume as force is removed and/or fluid 170 enters into the chamber. For example, as shown in FIG. 4A, when the first chamber 210 is compressed by a first compression force F₁, fluid 170 moves from the first chamber 210 through the delivery channel 230 into the second chamber 220, causing the second chamber 220 to increase volume. When the first compression force F₁ on the first chamber 210 is removed, the fluid 170 displaced from the first chamber 210 into the second chamber 220 via the delivery channel 230 may be then motivated from the second chamber 220 back to the first chamber 210 via the return channel 240 by a second compression force F₂ the second chamber 220, as shown in FIG. 4B.

Additionally, the first and second chambers 210, 220 may be resilient such that when the first chamber 210 is compressed and the second chamber 220 increases in volume, a removal of the first compression force F₁ from the first chamber 210 may cause the now-distended second chamber 220 to apply a second compressive force F₂ to the fluid 170 contained therein and force the fluid 170 to flow through the return channel 240 and back into the first chamber 210. Similarly, the first chamber 210 will be compressed until the force upon it is removed. After removal of the first compression force F₁, the first chamber 210 may expand due to its resiliency, and the expansion may create a region of low pressure within the first chamber 210 and draw fluid 170 in, thereby creating a fully cyclic flow from a single compression of the first chamber.

The second chamber 130, 220 in a micro-energy harvesting device may comprise a self-recovering chamber, such as the spiral chamber 270 shown in FIG. 4C with a spring fluid 280 disposed therein. In another embodiment, the self-recovering chamber may comprise an extended channel in a shape other than a spiral. In yet another embodiment, the self-recovering chamber may comprise a spring.

The spring fluid 280 may be more compressible than the fluid 170 such that when a force is applied to the first chamber 120, 210 the reduction in volume of the first chamber 120, 210 causes the fluid 170 to flow into the spiral chamber 270 and preferentially compress the spring fluid 280. In an embodiment, the spring fluid 280 may comprise a compressible liquid. In another embodiment, the spring fluid 280 may comprise a gas. In yet another embodiment, the spring fluid 280 may compress substantially according to Hooke's Law and spiral chamber 270 may, therefore, substantially behave as a coil spring with respect to the fluid 170 flowing into the spiral chamber 270. Such spiral chamber 270 and spring fluid 280 may provide greater compliance and durability than a piston- or diaphragm-type chamber, which rely upon the deformation or movement of the structure of the chamber itself. Furthermore, a self-recovering chamber may reduce or eliminate the need for a reciprocal pressure on the second chamber 130, 220 in order to return the fluid 170 to the first chamber 120, 210, rendering the energy harvesting device suitable for additional applications.

A device 100b such as depicted in FIGS. 4A-4C may only create a cyclic pulse of the fluid 170 through the device 100b. The device 100b will return to an equilibrium point after a net force is applied to either chamber relative to the other. Unfortunately, this device still incorporates the limitations of the embodiment depicted in FIG. 1, because the fluid 170 still merely cycles between a first chamber 120, 210 and a second chamber 130, 220 regardless whether a single channel 110 or a pair of channels (delivery 230 and return 240) provide the fluid communication between the chambers. However, by utilizing the delivery channel 230 and the return channel 240 in tandem to motivate a plurality of magnetic components 140 spaced apart from one another by a plurality of nonmagnetic components 150 through a plurality of coils 160, a more efficient conversion of mechanical energy may be realized.

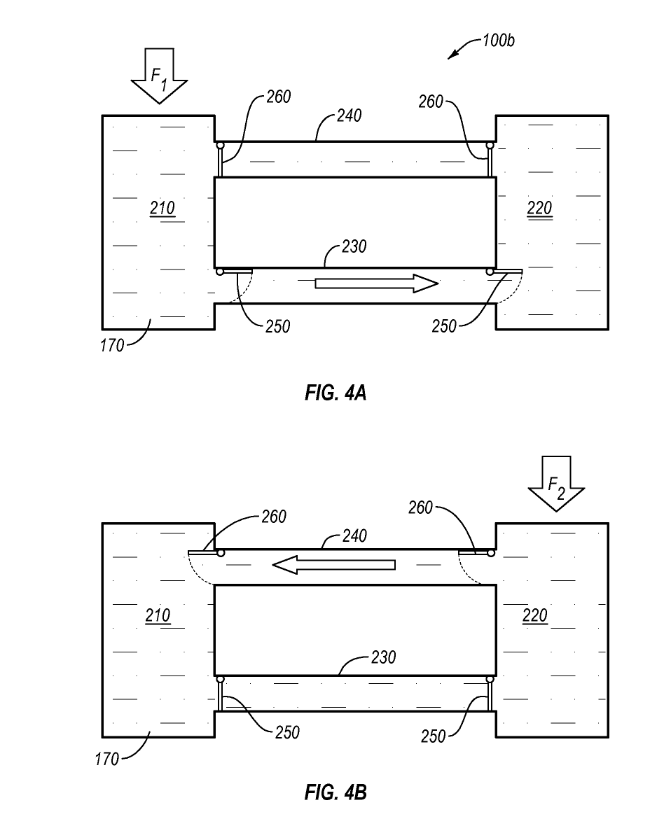

As shown in FIG. 5, in some embodiments, a circulation channel 290 containing a plurality of magnetic components 140 spaced apart from one another by a plurality of nonmagnetic components 150 may be disposed in fluid communication with the delivery channel 230 and the return channel 240. In an embodiment, the fluid communication between the flow direction of the fluid 170 in the circulation channel 290 and the fluid 170 in the delivery channel 230 may be substantially tangential. A path of travel for magnetic components 140 and nonmagnetic components 150 disposed within this circulation channel 290 or motivated by the fluid 170 moving therethrough is not limited to the length of the circulation channel 290, but enables multiple circulations creating an effectively infinite travel path. The delivery channel 230, return channel 240, and circulation channel 290 may have a circular cross-section, an ellipsoid cross-section, a rectangular cross-section, any other suitable polygonal cross-section, or combinations thereof. The delivery channel 230, return channel 240, and circulation channel 290 may have a cross-section suitable to de-amplify the input force applied to the first chamber 210 or second chamber 220. In an embodiment, the delivery channel 230, return channel 240, and the circulation channel 290 may have cross-sectional dimensions of about 4.5 mm by 4.5 mm. For example, the delivery channel 230, return channel 240, and the circulation channel 290 may have a diameter of about 4.5 mm. As mentioned earlier, the magnetic components 140 may have cross-sectional dimensions approximately equal to the cross-sectional dimensions of the delivery channel 230, return channel 240, and/or circulation channel 290. In another embodiment, the magnetic components 140 may have a diameter about 70% of a cross-sectional dimension of the delivery channel 230, return channel 240, and/or circulation channel 290. In yet another embodiment, the magnetic components 140 may have a cross-sectional dimension between 70% and 100% of the diameter of the delivery channel 230, return channel 240, and/or circulation channel 290.

When the delivery channel 230 is in fluid communication with the circulation channel 290, the flow of fluid 170 through the delivery channel 230 when the first chamber 210 is compressed may provide an impulse to the magnetic components 140 and nonmagnetic components 150. As depicted in FIG. 5, the magnetic components 140 and nonmagnetic components 150 may be disposed within the circulation channel 290. The motion of the magnetic components 140 past the coils 160 may induce a current therein, which may be harvested from the device 100c. In other embodiments, the magnetic components 140, nonmagnetic components 150, and coils 160 may be disposed outside the circulation channel 290, and the magnetic and nonmagnetic components 140, 150 may be motivated by the fluid movement within the circulation channel 290. When the flow of the fluid 170 through the delivery channel 230 stops, the inertia of the magnetic components 140 and nonmagnetic components 150 may cause the magnetic components 140 and nonmagnetic components 150 to continue moving and inducing further current in the coils 160.

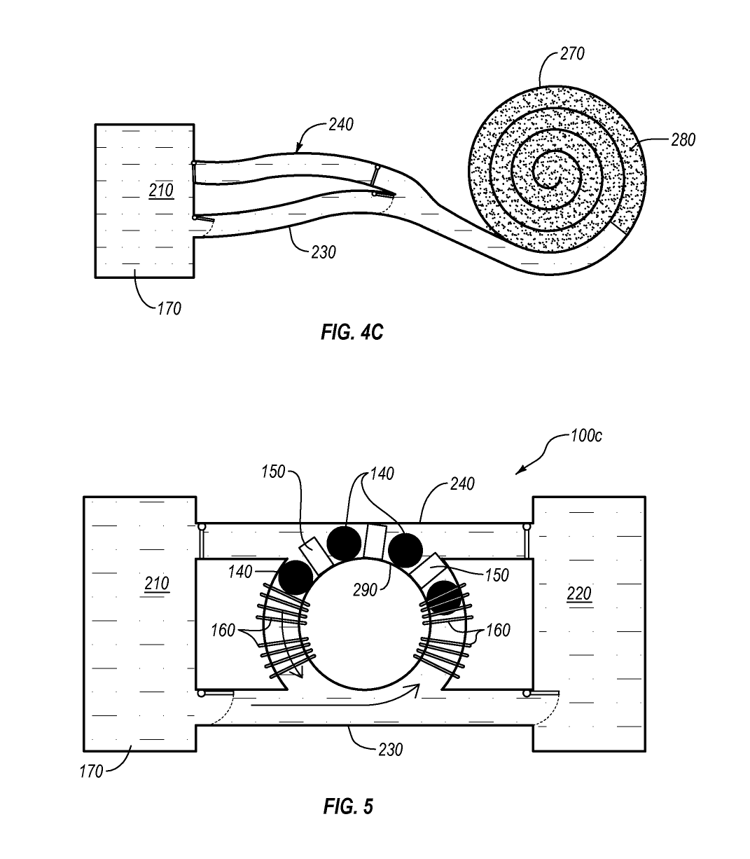

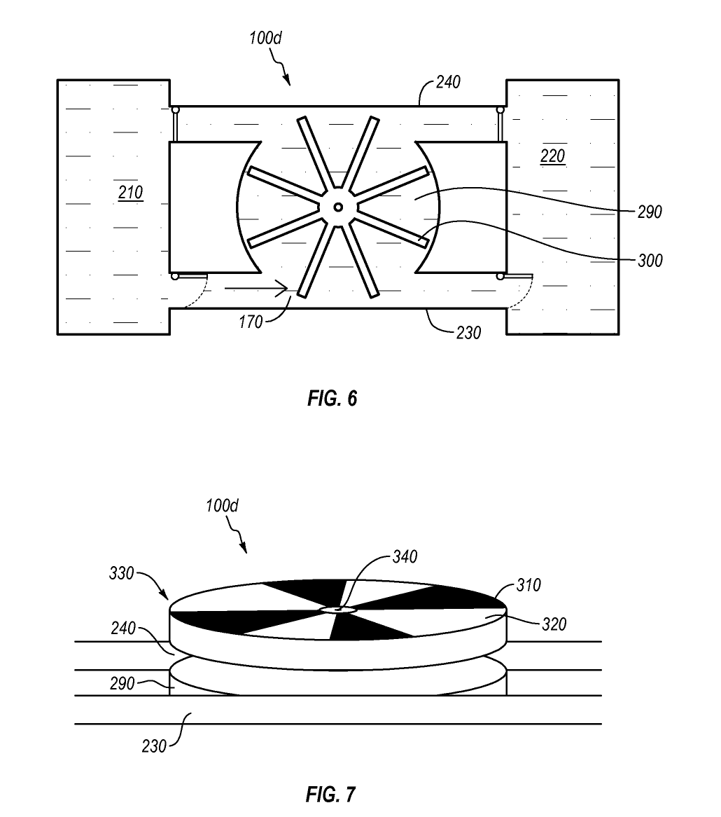

FIGS. 6 and 7 depict a micro-energy harvesting device 100d in which the plurality of magnetic components 140 and nonmagnetic components 150 are disposed outside of the circulation channel 290. The embodiment may be functionally similar to the micro-energy harvesting device 100c depicted in FIG. 5, but the fluid 170 acts upon the plurality of magnetic components 140 and nonmagnetic components 150 indirectly. The circulation channel 290 may include a paddlewheel 300 or similar device that may rotate when acted upon by the movement of the fluid 170 through the delivery channel 230 and/or return channel 240. The cyclic flow from the first chamber 210 to the second chamber 220 and from the second chamber 220 to the first chamber 210 may occur similarly to any of the previously described embodiments. Similar to the magnetic components 140 disposed within the circulation channel 290, the paddlewheel 300 may have a cross-sectional height approximately equal to the cross sectional area of the circulation channel 290. In another embodiment, the paddlewheel 300 may have a cross-sectional height approximately 70% of a cross sectional height of the circulation channel 290. In yet another embodiment, the paddlewheel 300 may have a cross-sectional height between 70% and 100% of a cross sectional height of the circulation channel 290.

The substantially unidirectional flow may rotate the paddlewheel 300 that acts upon external magnetic components 310 and external nonmagnetic components 320. The external magnetic components 310 and external nonmagnetic components 320 may alternate in a similar fashion to the magnetic components 140 and nonmagnetic components 150 described in relation to FIGS. 1 through 5. As shown in FIG. 7, the external magnetic components 310 and external nonmagnetic components 320 are disposed on a flywheel 330 that is connected to the paddlewheel 300 by an axle 340. In some embodiments, the axle 340 may include a unidirectional hub (not shown) allowing force to be applied by the paddlewheel 300 to the flywheel 330, which may continue to rotate freely. In other embodiments, the flywheel 330 may be connected to the paddlewheel 300 through other mechanisms, such as a chain drive, a screw drive, non-mechanical forces such as a magnetic force, or combinations thereof. The flywheel 330 may rotate, and, as it does, move the external magnetic components 310 and external nonmagnetic components 320 past one or more coils (not shown) inducing a current therethrough.

As shown in FIG. 7, the flywheel 330 may comprise alternating sectors of external magnetic components 310 and external nonmagnetic components 320. In other embodiments, the flywheel 330 may be an external nonmagnetic component 320 with external magnetic components 310 disposed therein. In yet other embodiments, the flywheel 330 may be a ring having external magnetic components 310 and external nonmagnetic components 320 disposed around the perimeter of the ring in an alternating fashion.

As mentioned earlier, a micro-energy harvest device in accordance with the present disclosure may be functionally symmetrical. Therefore, an equivalent process may occur during compression of the first chamber 210 and a resulting flow of fluid 170 through the delivery channel 230 or the second chamber 220 and a resulting flow of fluid 170 through the return channel 240. By allowing for a functionally infinite travel path for the magnetic components 140 or external magnetic components 310 in which to induce current in the coils 160, a circulatory energy harvesting device 100c, 100d may harvest energy more efficiently and completely than a linear energy harvesting device 100a such as shown in FIG. 1.

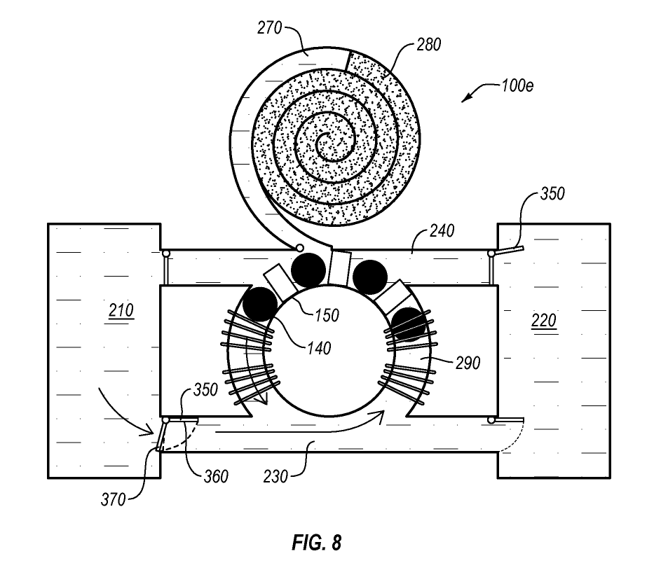

In addition to a device having first and second chambers such as that described in relation to FIGS. 1 through 7, a device may include a self-flow-stop in a channel to prevent over pressurization of the channels. FIG. 8 depicts a micro-energy harvesting device 100e having a self-flow-stop mechanism. A self-flow-stop microvalve 350, for example, includes a self-flow-stop, such that the self-flow-stop microvalve 350 opens under pressure, but excessive pressure or flowrate closes the microvalve 350, as illustrated in FIG. 8. The closure of the microvalve under excessive pressure or flowrate may prevent damage to the smaller volume channels and localize the high pressure to the chambers which may be more robust in construction. In another embodiment, the flow-stop may occur when the magnetic components 140 have completed a power generation cycle.

In some embodiments, the self-flow-stop microvalve 350 may include a plurality of members positioned approximately 90° from one another. A first member 360 may be urged into an open position at the fluid 170 moves from the first chamber 210 toward the second chamber 220. When the first member 360 is urged into a fully open position by high fluid pressures, a second member 370 of the self-flow-stop microvalve 350 may be simultaneously urged into a closed position to limit or prevent over-pressuring of the delivery channel 230, return channel 240, and/or circulation channel 290. In other embodiments, the self-flow-stop microvalve 350 may include a plurality of members positioned greater than 90° from one another. The first member 360 and/or the second member 370 may be resilient. The self-flow-stop microvalve 350 may obstruct but not prevent the flow of fluid 170 when the first member 360 is urged into a fully open position and the second member 370 is, thereby, urged near the delivery channel 230, return channel 240, and/or circulation channel 290. During higher flow rates, the fluid 170 may flex the resilient second member 370 to obstruct the flow more greatly or substantially prevent flow of the fluid 170. In other embodiments, the first member 360 and second member 370 may have a resilient connection therebetween. A resilient connection may allow the first member 360 and second member 370 to move relative to one another irrespective of the rigidity of the first member 360 and/or second member 370.

For example, a self-flow-stop microvalve 350 in the example of a shoe bed, as described herein, may allow the movement of fluid 170 when a user applies a low force during walking activities. The self-flow-stop microvalve 350 may at least partially limit the movement of fluid 170 when the user applies a medium force during running activities. The self-flow-stop microvalve 350 may substantially prevent the movement of fluid 170 when a user applies a high force while jumping or performing other actions that result in high forces to the sole.

Additionally, a device 100e may include a third chamber or channel to relieve pressure in the system. The third chamber may be a self-recovering chamber, such as an extended channel, a spring, or a spiral chamber 270 similar to that described in relation to FIG. 4C. The spiral chamber 270 may include a spring fluid 280 therein that may substantially behave as a coil spring with respect to the fluid 170 flowing into the spiral chamber 270. The spring fluid 280 may dissipate energy from over-pressurization with less deformation to the structure of the device 100e. Lessening deformation of the device 100e may reduce wear on the device 100e and/or increase operational lifetime.

For example, a self-recovering chamber may facilitate dissipation of large input forces over a longer channel and, therefore, surface area. The larger surface area may reduce the pressure in the device sufficiently to prevent rupturing of the channel or of a chamber. A self-recovering chamber disposed in fluid communication with the device but in addition to the first and second chambers may operate as a pressure-release channel, allowing flow into the self-recovering chamber when a pressure in the device exceeds a predetermined amount based on the volume, thickness, and material of the device.

The articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. For example, any element described in relation to an embodiment herein may be combinable with any element of any other embodiment described herein. Numbers, percentages, ratios, or other values stated herein are intended to include that value, and also other values that are “about” or “approximately” the stated value, as would be appreciated by one of ordinary skill in the art encompassed by embodiments of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to embodiments disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the embodiments that falls within the meaning and scope of the claims is to be embraced by the claims.

The terms “approximately,” “about,” and “substantially” as used herein represent an amount close to the stated amount that still performs a desired function or achieves a desired result. For example, the terms “approximately,” “about,” and “substantially” may refer to an amount that is within less than 5% of, within less than 1% of, within less than 0.1% of, and within less than 0.01% of a stated amount. Further, it should be understood that any directions or reference frames in the preceding description are merely relative directions or movements.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A microfluidic device for harvesting energy, the device comprising:
a first chamber;
a second chamber;
a circulation channel in fluid communication with the first and second chambers;
at least one coil disposed around the circulation channel;
a fluid disposed at least partially within the first chamber, second chamber, and circulation channel;
a plurality of magnetic components separated from one another by a plurality of non-magnetic components; and
a plurality of microvalves disposed adjacent the first and second chambers, the plurality of microvalves configured to allow substantially unidirectional flow of the fluid,
wherein the plurality of magnetic components are configured such that the flow of the fluid moves the magnetic components.

2. The device of claim 1, wherein at least the first chamber is configured to change volume.

3. The device of claim 2, wherein the first chamber comprises a piston.

4. The device of claim 2, wherein the first chamber comprises a diaphragm.

5. The device of claim 1, wherein at least one of the first and second chambers comprises a spring fluid.

6. An energy harvesting system, comprising:
the energy harvesting device of claim 1;
an energy storage device having electrical terminals; and
an electrically conductive connection between the coil of the energy harvesting device and the electrical terminals of the energy storage device.

7. The device of claim 1, further comprising a first channel providing fluid communication between the first chamber and second chamber; and
a second channel providing fluid communication between the second chamber and first chamber.

8. The device of claim 7, wherein at least one of the first channel and second channel are in fluid communication with the circulation channel.

9. The device of claim 8, wherein the fluid communication the circulation channel and the at least one of the first channel and second channel is substantially tangential.

10. A microfluidic device for harvesting energy, the device comprising:
a channel configured to be pressurized;
a fluid contained within the channel;
a chamber in fluid communication with an end of the channel, the chamber having a compressible fluid disposed therein;
a plurality of magnetic elements separated from one another by nonmagnetic spacers, wherein the fluid is capable of moving the plurality of magnetic elements and the nonmagnetic spacers; and
a plurality of coils configured to enable movement of the plurality of magnetic elements therethrough, the coils comprising an electrically conductive material.

11. The microfluidic device of claim 10, wherein the channel configured to be pressurized is a circulation channel.

12. The microfluidic device of claim 10, wherein the chamber is a spiral.

13. The microfluidic device of claim 10, further comprising a second chamber, the second chamber being configured to change volume.

14. A method of micro-energy harvesting, the method comprising:
receiving an input force with a first chamber;
transmitting an input force to a fluid disposed in the first chamber;
moving the fluid from the first chamber through a circulation channel and into a second chamber;
transmitting energy from a movement of the fluid to a movement of a plurality of magnetic components; and
converting the movement of the plurality of magnetic components to electrical energy.

15. The method of claim 14, further comprising moving fluid from the second chamber to the first chamber.

16. The method of claim 15, wherein moving the fluid from the second chamber to the first chamber comprises moving the fluid through at least one microvalve.

17. The method of claim 14, further comprising storing the electrical energy in a storage device.

18. The method of claim 14, wherein transmitting energy from the movement of the fluid to a movement of the plurality of magnetic components comprises moving the plurality of magnetic components within the circulation channel.

19. The method of claim 18, further comprising circulating the plurality of magnetic components within the circulation channel after removing the input force.

20. The method of claim 14, wherein moving the fluid from the first chamber through the circulation channel and into the second chamber comprises moving the fluid through at least two microvalves.
